(19) United States
(12) Patent Application Publication
(10) Pub. No.: US 2019/0347707 A1
(43) Pub. Date: Nov. 14, 2019

(54) System and Method for Recommending Restaurant Food Items

(71) Applicant: Michael Gayed, Forest Hills, NY (US)

(72) Inventor: Michael Gayed, Forest Hills, NY (US)

(21) Appl. No.: 16/406,013

(22) Filed: May 8, 2019

Related U.S. Application Data
(60) Provisional application No. 62/668,411, filed on May 8, 2018.

(51) Int. Cl. G06Q 30/06

(52) U.S. Cl. CPC G06Q 30/0631; G06F 16/951

(57) ABSTRACT

A system for recommending restaurant menu items to a user is described. The system includes a mobile application running on a mobile device of the user. The mobile device accesses information from a server accessing a database of menu items that match with nutritional or dietary needs of a user of the mobile application. The database of menu items is created by a crawler algorithm that finds and stores information in the database relating to menu items at restaurants and for each of those menu items matching a recipe with nutritional and ingredient information to the recipe.

### REFERENCE TO RELATED APPLICATIONS

This application is a nonprovisional application of and claims priority to U.S. Provisional Application No. 62/668,411, filed on May 8, 2018 entitled SYSTEM AND METHOD FOR RECOMMENDING RESTAURANT FOOD ITEMS to Inventor Michael Gayed, which is herein incorporated by reference in its entirety.

### BACKGROUND

Conventionally, there is interest in dieting apps and other computer programs which help people get information on and maintain a variety of diets. There are also many different diets which people are interested in. Further, many people eat outside the home at restaurants and the like for one or more meals per day. Because of this, people have difficulty staying on their particular diet because they don't know where to get restaurant dishes that fit their diet or they do not know the nutritional content of the food that they receive from restaurants. Therefore, there is a need for a way in which to search for foods which are in line with their diets at nearby restaurants. What would further be desirable is a mobile application which could search for such foods at restaurants nearby and help the user in making informed restaurant choices.

In addition to the illustrative aspects, embodiments, and features described above, further aspects, embodiments, and features will become apparent by reference to the drawings and the following detailed description.

### SUMMARY

An exemplary embodiment relates to a system for recommending restaurant menu items to a user. The system includes a mobile application running on a mobile device of the user. The mobile device accesses information from a server accessing a database of menu items that match with nutritional or dietary needs of a user of the mobile application. The database of menu items is created by a crawler algorithm that finds and stores information in the database relating to menu items at restaurants and for each of those menu items matching a recipe with nutritional and ingredient information to the recipe.

Another exemplary embodiment relates to a method of providing restaurant menu item recommendations to a user. The method includes determining a geographical region in which to search for restaurants in a restaurant database. The method also includes retrieving from a restaurant menu database menu information for a restaurant and storing, in a main database information relating to each menu item from the menu information. Further, the method includes matching each menu item with at least one of a recipe, a listing of ingredients, and nutritional information for the menu item in at least one of a recipe database and a nutritional information database. Further, the method includes storing, the at least one of a recipe, a link to the recipe, a listing of ingredients, and nutritional information for the menu item, with an association with the menu item in a main database.

Yet another exemplary embodiment relates to a system for recommending restaurant menu items to a user. The system includes a mobile application running on a mobile device of the user. The mobile device provides location information to a server and provides dietary preference information to the server. The server runs program steps that include matching the dietary preference information to restaurants within a predetermined distance from the location that have menu items that match the dietary preference and that are open at the time of day. The program steps of the server also including sorting the matched restaurants according to a predetermined metric and displaying a listing of the restaurants to a user of the mobile application.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is a depiction of a networking system including a plurality of servers and mobile devices connected to a communications network.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In accordance with an exemplary embodiment, a mobile application may be used to help keep a user's particular diet on track. The mobile application may aid in finding dishes that are suited to the user's diet at nearby restaurants. People on diets are often tempted by restaurant menu items when they are out. A mobile app which provides ways of finding healthy, local menu options which are in line with that particular diet may be very useful to curb such temptation. Exemplary diets may include but are not limited to low calorie, low carb, high protein, high fiber, low fat, balanced, vegan, vegetarian, gluten-free, Atkins, etc. Using a mobile application which provides menu item suggestions from nearby restaurants that fit the user's diet make it easy for users to stay on their diet. Also, in an exemplary embodiment, it may be desirable for a user to be connected to a network of dieters who can share their diet meal plans, favorite restaurants, and dishes, and healthy recipes that match with dieting goals. People who are on similar diets may be networked with you providing an environment of information sharing and motivation.

In an exemplary embodiment, a user using the mobile app will at first set a goal, for example inputting current or target weight. The user may also update their weight at any time while tracking meals. A user may also devise a strategy within the app such as selecting a specific diet that the user is following. The diets may be any of a number of diets including but not limited to low-carb diets, low calorie diets, the Atkins diet, vegetarian diets, gluten-free diets, vegan diets, etc. Whenever the user is interested in eating at a restaurant, the user may find healthy eats that maintains the user's diet by searching for dishes served at nearby restaurants which fall near or within the constraints of the diet. The dishes maybe saved for later access. The app may also be used for planning upcoming meals from nearby restaurants. The app also provides the ability to identify a recipe that matches your diet and optionally may allow checking ingredients in the recipe. The app allows you to get detailed nutrition information on dishes that interest you. The app also allows you to track things like calories or carbs eaten during the day. The app may also allow you to rate and report dishes and restaurants for users of the social network. The app further allows users to share experiences with various dishes or recipes with friends who may be on the same diet as them.

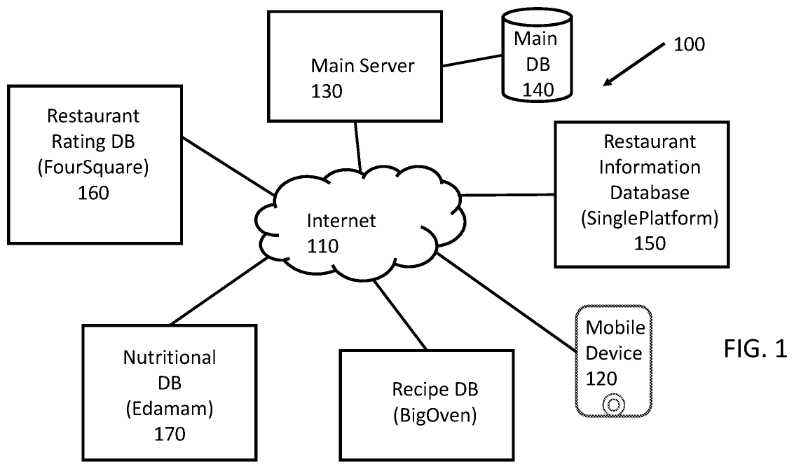

Referring to FIG. 1, a networked system of servers and devices 100 includes the internet 110 as a communication system. The communication system may be any of a variety of communication systems including the internet and cellular phone networks or other communication networks. One or more mobile devices 120 may be connected to the internet through a cellular phone network or Wifi network and running a mobile application thereon. In order to implement the mobile application, the mobile devices connect to a cloud server 130 running the service software. The server software enables a user to carryout searches for dishes at nearby restaurants as well as storing user preferences, accounts, and information and further enabling social networking features. The server software enables storing of restaurant, recipe, nutrition, and user information in a main database 140. The restaurant, recipe, and nutrition information are retrieved from other sources of information including but not limited to a restaurant menu and information database 150 (such as but not limited to SinglePlatform), a restaurant rating database 160 (such as but not limited to FourSquare), and a Nutritional Database 170 (such as but not limited to Edamam). Each of these databases are accessible through the communication network 110 or the like. The databases are harvested for information at regular intervals to maintain a current dataset.

In an exemplary embodiment, the server software runs a Crawler Algorithm to maintain a current database of restaurant venues and their menu offerings. The Crawler Algorithm makes a call to the SinglePlatform database which is a service that provides information about restaurants and their menu offerings and can be accessed for a service fee. Any such service that provides the needed information about restaurants and their offerings may be used without departing from the scope of the invention. The Crawler Algorithm is unique in that it brings together multiple databases for gathering current restaurant and dish information as well as nutritional and ingredient or health label analysis of dishes. The Crawler Algorithm calls not only SinglePlatform, but also may call a restaurant rating database such as but not limited to the FourSquare database to provide restaurant ratings and restaurant information (such as but not limited to type of cuisine and hours). The Crawler algorithm also may access one or more recipe databases for estimating the ingredient content and nutritional content of various menu items. The recipe databases include but are not limited to the Edamam Nutritional Database and the BigOven recipe database.

The Crawler Algorithm is roughly outlined below:

### Crawler Algorithm:

1. Every X time period, the Crawler will make a call to the SinglePlatform (SP)

/locations/updated since/passing in as a date parameter the last time the crawler ran.
2. For each venue returned from the call to SP above, do:

a. If the venue “has_menus”:“true” & “business_type”:“Restaurant” & “out_of_business”:“false”
i. Check local Venues table to see if an existing Venue exists with that SPID:
   1. If no, then create a new Venue object in Main database with all of its MenuItems including the following Venue/MenuItem information:
      a. Dish Name
      b. Dish Description
      c. Dish Photo, Dish Price (if available)
      d. SPV2ID needs to be associated with the Venue in Main database
      e. Email
      f. Location.Address1
      g. Location.Address2
      h. Location.City
      i. Location. State
      j. Location.Zip
      k. Latitude
      l. Longitude
      m. Phone
      n. FoursquareID
      o. VenueHours (if available)
      p. Average Price (if available)
   2. If yes, then update the Venue object in Main database with the latest information pulled from SP.
   ii. If the venue returned from SP also contains a “foursquare_id”, we call into the Foursquare API and retrieve the following information and associate it with the Venue:
      1. Restaurant rating
      2. Restaurant hours
      3. Price Range
      4. Cuisine ID
   iii. If the Venue does not contain a “foursquare_id”, we attempt to Search for the Venue using the Foursquare Venues search API using the following fields:
      1. ll=latitude/longitude pulled from SP
      2. intent=match
      3. query=<Venue name>
   If a Foursquare match is found we associate the Venue with the FoursquareID and pull the same information as ii.)
b. If the venue “has menus”:“true” & “business type”:“Restaurant” & “out_of_business”:“true”
   i. Check Main database local Venues table to see if that Venue already exists in Main database. If the Venue does exist we inactivate the Venue so it no longer appears in the app as it is now closed.
3. For each MenuItem stored in 3, if the Menu name does not contain any words on the Exclusion List:
   a. Perform a “fuzzy” string comparison between the MenuItem in Main database and the Edamam Nutritional Database.
   b. Based on the result of a.) if find a candidate match above a certain cosine distance similarity score, then associate the MenuItem in question with the Edamam Recipe.
      i. Use the nutritional information from the Edamam database to extract and compute a set of diet-labels and attach it to the MenuItem in Main Database.
      ii. Use the Gluten, Vegetarian, and Vegan tags from the Edamam database and associate it with the Menu Item in Main Database.
   c. If no match to an Edamam generic recipe or the “fuzzy” match score falls below a similarity score threshold, then mark the MenuItem as “hidden” so that it doesn't appear in the app but is then visible in the admin panel for manual cleaning of the data.

In accordance with an exemplary embodiment a crawler algorithm needs to be run on the BigOven database or other like database once for each Edamam recipe or like recipe. Accordingly, the Big Oven Crawler detailed below is run each time an Edamam recipe (or other like recipe) is added to the main database.

### BigOven Crawler

1. For each Edamam generic recipe in Main database, attempt to “fuzzy” match it to a BigOVen recipe:
   a. Call to BigOven api—http://api2.bigoven.com/recipes?pg=1&rpp=3&any_kw=
   b. For each result returned from Big Oven, perform a “fuzzy” string comparison on the returned dish title versus the dish searched. Apply one of two fuzzy matching algorithms:
      i. Levenshtein Distance
   c. Based on the result of b.) Select the returned Big Oven recipe that has the highest cosine distance similarity score and “associate it” with the Menu Item. (Also filter out and not associate any returned Big Oven dish if both scores fall below a certain threshold).
   d. For each Recipe from Big Oven which is matched to a Menu Item ONLY store the following metadata from BigOven in Main Database:
      i. Unique Big Oven ID
      ii.

In accordance with another exemplary embodiment, another version of the above algorithm may be used without departing from the scope of the invention. That alternative algorithm is as follows:

### Crawler Algorithm:

1. Every X time period, the Crawler will make a call to the SinglePlatform

/locations/updated since/passing in as a date parameter the last time the crawler ran.
2. For each venue returned from the call to SP above we do:
   a. If the venue “has_menus”:“true” & “business_type”:“Restaurant” & “out_of_business”:“false”
      i. We check our local Venues table to see if an existing Venue exists with that SPID:
         1. If no, then create a new Venue object in our database with all of its MenuItems including the following Venue/MenuItem information:
            a. Dish Name
            b. Dish Description
            c. Dish Photo, Dish Price will be attempted to be stored (even though we have found they are rarely populated)
            d. SPV2ID needs to be associated with the Venue in our database
            e. Email
            f. SPMenuItemID
            g. Location.Address1
            h. Location.Address2
            i. Location.City
            j. Location. State
            k. Location.Zip
            l. Latitude
            m. Longitude
            n. Phone
            o. FoursquareID
            p. VenueHours (if available)
            q. Average Price (if available)
         1. If yes, then we update the Venue object in our database with the latest information pulled from SP.
   ii. If the venue returned from SP also contains a “foursquare_id”, we call into the Foursquare API and retrieve the following information and associate it with the Venue:
      1. Restaurant rating
      2. Restaurant hours
      3. Price Range
      4. Cuisine ID
   iii. If the Venue does not contain a “foursquare_id”, we attempt to Search for the Venue using the Foursquare Venues search API using the following fields:
      1. ll=latitude/longitude pulled from SP
      2. intent=match
      3 query=<Venue name>
      4. If a Foursquare match is found we associate the Venue with the FoursquareID and pull the same information as ii.)
   b. If the venue “has_menus”:“true” & “business_type”:“Restaurant” & “out_of_business”:“true”
      i. We check our local Venues table to see if that Venue already exists in our database. If the Venue does exist we inactivate the Venue so it no longer appears in the app as it is now closed.
   c. For each Photo which is returned from SinglePlatform along with the Venue data, we:
   d. Extract the items list form the Photo and for every ItemID in the list we:
   e. Match that ItemID to the SPMenuItemID returned by SP for each Menu Item in the Venue's menu.
   f. If we find a Menu item that has a SPMenuItemID which matches the ItemID, we update the MenuItem record's SinglePlatformImageURL field to include the URL for the Photo we are processing.
2. For each MenuItem stored in 3, if the Menu name does not contain any words on the Exclusion List:
   a. We perform a “fuzzy” string comparison between the MenuItem in our database and the Edamam Nutritional Database.
   b. Based on the result of a.) if we find a candidate match above a certain cosine distance similarity score, we will associate the MenuItem in question with the Edamam Recipe.
      i. We use the nutritional information from the Edamam database to extract and compute our own set of diet-labels and attach it to the MenuItem.
      ii. We will use the Gluten, Vegetarian, Vegan tags from the Edamam database and associate it with the Menu Item.
   c. If we do not find a match to a Edamam generic recipe or the “fuzzy” match score falls below a similarity score threshold, then we mark the MenuItem as “hidden” so that it doesn't appear in the app but is then visible in the admin panel for manual cleaning of the data.

### BigOven Crawler

1. For each Edamam generic recipe in our database, we will attempt to “fuzzy” match it to a BigOVen recipe:
   a. http://api2.bigoven.com/recipes?pg=1&rpp=3&any_kw=
   b. For each result returned from Big Oven, we perform a “fuzzy” string comparison on the returned dish title versus the dish we were searching for. We will start with two fuzzy matching algorithms:
      i. Cosine Distance
      ii. Levenshtein Distance
   c. Based on the result of b.) we will select the returned Big Oven recipe that has the highest cosine distance similarity score and “associate it” with the Menu Item. (We will also filter out and not associate any returned Big Oven dish if both scores fall below a certain threshold).
   d. For each Recipe from Big Oven which is matched to a Menu Item we ONLY store the following metadata from BigOven:
      i. Unique Big Oven ID

In accordance with exemplary embodiments, variations in the above processes and steps may be used without departing from the scope of the invention. For example, the databases used are not limited to those disclosed. There may be used other databases that include the same or similar information and various combinations of them may be used in a similar fashion without departing from the scope of the invention. Also, any of a variety of fuzzy matching algorithms can be used not limited to those disclosed above. In an exemplary embodiment, the Crawler algorithm is instrumental in creating the functionality of the diet app.

In accordance with an exemplary embodiment an alternative Crawler Algorithm is roughly outlined below and can replace the one above or be used in conjunction therewith. Features of each algorithm could also be combined in various ways without departing from the scope of the invention. The algorithm is as follows:

### Reporting

The backend may be configured to generate a daily report in CSV format with the following information included for each MenuItem in the Database:
MenuItemID
Venue Name
Venue Foursquare ID
Single Platform Dish Item ID
Single Platform Dish Name
Matched Edamam Recipe ID
Matched Edamam Recipe Name
Matched Edamam Fuzzy Match Score (Cosine distance score)
Matched BigOven Recipe ID
Matched BigOven Recipe Name
Matched BigOven Fuzzy Match Score (Cosine distance score)
Total Calories (from matched Edamam Generic Recipe)
Total Carbs (from matched Edamam Generic Recipe)
Total Fat (from matched Edamam Generic Recipe)
Total Protein (from matched Edamam Generic Recipe)
HowUDish calculated diet labels.

Interaction with the app is created by the user and executed by the device. For example, an outline of the functionality of the app is provided below in two different app algorithms. These exemplary embodiments are not limited to the steps described.

App Algorithm:
1. Given the user's lat/long and dietary restrictions that are stored in the app, run a query on the main database that basically asks:
   a. Provide all active Menu Items (where Active=Single Platform Menu Item that we've successfully matched to an Edamam Recipe) that are in a “open” Venue within X miles of device location where the Menu Item matches the user's dietary preferences and a user specified set of filtering criteria determined in the app
   b. Sort them by distance
2. The set of results are sent to the app, with each set of results returned from the server the app will make direct calls to Big Oven to return and display the following information:
   a. Photos
   b. Recipe/Instructions Text
3. Display to the user.

Any of a variety of other features may be added to the mobile app. The mobile app may for example be configured with social networking features. For example, the mobile app may be configured to match users together to meet at a restaurant nearby that has dishes that meet their diet. In another exemplary embodiment, a mode may be provided which lets a user who is very hungry to get an immediate top (top six, e.g.) dishes nearby indicating that the user has immediate hunger needs. The app may also be configured with a mode that allows a user to cheat on their diet by displaying the nearby dish would be the least bad for the diet but still is a cheat on the diet.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by claims.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A system for recommending restaurant menu items to a user, comprising:
a mobile application running on a mobile device of the user, the mobile device accessing information from a server accessing a database of menu items that match with nutritional or dietary needs of a user of the mobile application, the database of menu items being created by a crawler algorithm that finds and stores information in the database relating to menu items at restaurants and for each of those menu items matching a recipe with nutritional and ingredient information to the recipe.

2. The system of claim 1, wherein the crawler algorithm also finds and stores restaurant rating information with the menu items.

3. The system of claim 1, wherein the crawler algorithm also finds and stores restaurant rating information with the menu items by accessing the SinglePlatform database.

4. The system of claim 1, wherein the crawler algorithm determines menu item nutritional and ingredient information by matching the menu items with recipes from a recipe database.

5. The system of claim 1, wherein the crawler algorithm determines menu item nutritional and ingredient information by matching the menu items with recipes from a recipe database, wherein the recipe database includes the Edamam database.

6. The system of claim 1, wherein the mobile application determines the location of the user.

7. The system of claim 1, wherein the mobile application determines the location of the user and locates restaurants, having the menu items that match with the nutritional and dietary needs of the user, within a certain radius of the user.

8. The system of claim 1, wherein the mobile application determines the location of the user and locates restaurants, having the menu items that match with the nutritional and dietary needs of the user, within a certain radius of the user, the mobile application further mapping directions to a restaurant chosen by the user.

9. The system of claim 1, wherein the mobile application provides photos of the menu items.

10. The system of claim 1, wherein the dietary needs of the user include at least one of low calorie, low carb, high protein, high fiber, low fat, balanced, vegan, vegetarian, gluten-free, Atkins.

11. A method of providing restaurant menu item recommendations to a user, comprising:
determining a geographical region in which to search for restaurants in a restaurant database;
retrieving from a restaurant menu database menu information for a restaurant;
storing, in a main database information relating to each menu item from the menu information;
matching each menu item with at least one of a recipe, a listing of ingredients, and nutritional information for the menu item in at least one of a recipe database and a nutritional information database; and
storing, the at least one of a recipe, a link to the recipe, a listing of ingredients, and nutritional information for the menu item, with an association with the menu item in a main database.

12. The method of claim 11, further comprising:
determining the best match for each menu item with at least one of a recipe, a listing of ingredients, and nutritional information for the menu item in at least one of a recipe database and a nutritional information database.

13. The method of claim 11, further comprising:
providing a set of coordinates that define the boundaries of the geographical region.

14. The method of claim 11, wherein the menu database includes the SinglePlatform Database.

15. The method of claim 11, wherein the recipe database includes the Edamam Database.

16. The method of claim 11, wherein the recipe database includes the Big Oven Database.

17. The method of claim 11, further comprising:
associating at least one diet label with each menu item.

18. The method of claim 11, further comprising:
associating at least one diet label with each menu item; and
retrieving from the main database more than one menu item based on the diet label.

19. The method of claim 11, further comprising:
associating at least one diet label with each menu item;
receiving a request from a user menu items related to a specific diet label;
retrieving from the main database more than one menu item based on the specific diet label.

20. A system for recommending restaurant menu items to a user, comprising:
a mobile application running on a mobile device of the user, the mobile device providing location information to a server and providing dietary preference information to the server;
the server running program steps including:
matching the dietary preference information to restaurants within a predetermined distance from the location that have menu items that match the dietary preference and that are open at the time of day;
sorting the matched restaurants according to a predetermined metric; and
displaying a listing of the restaurants to a user of the mobile application.
